(19) United States
(12) Patent Application Publication
(10) Pub. No.: US 2025/0328419 A1
(43) Pub. Date: Oct. 23, 2025

(54) APPARATUSES, SYSTEMS AND METHODS FOR MEMORY DEVICE ERROR LOGGING FOR OFF-LINING

(71) Applicant: Micron Technology, Inc., Boise, ID (US)

(72) Inventors: Owen Straub, Boise, ID (US); Anthony M. Geidl, Boise, ID (US); Dale H. Hiscock, Boise, ID (US); John R. Lynch, Boise, ID (US); Evan C. Pearson, Boise, ID (US)

(73) Assignee: Micron Technology, Inc., Boise, ID (US)

(21) Appl. No.: 19/089,317

(22) Filed: Mar. 25, 2025

Related U.S. Application Data
(60) Provisional application No. 63/635,784, filed on Apr. 18, 2024.

(51) Int. Cl. G06F 11/10

(52) U.S. Cl. CPC G06F 11/106; G06F 11/1016; G06F 11/1068

(57) ABSTRACT

A memory device includes an off-lining logging circuit. The memory device detects errors in the memory array as well as one or more addresses which identify where in the array the error was located. The off-lining logging circuit counts errors in different portions of the array, such as sections and/or column planes, based on the addresses. If the count value crosses a threshold, the portion may be identified as a candidate for off-lining. In some examples, a host device may receive off-lining candidate address information from the memory and off-line the identified portions.

### CROSS REFERENCE TO RELATED APPLICATION(S)

This application claims the benefit under 35 U.S.C. § 119 of the earlier filing date of U.S. Provisional Application Ser. No. 63/635,784 filed Apr. 18, 2024 the entire contents of which is hereby incorporated by reference in its entirety for any purpose.

### BACKGROUND

This disclosure relates generally to semiconductor devices, and more specifically to semiconductor memory devices. In particular, the disclosure relates to volatile memory, such as dynamic random access memory (DRAM). During operation, information is stored on the memory device in an array of memory cells. Certain memory cells may be defective or otherwise prone to errors. It may be useful to identify memory cells which are more prone to errors in order to avoid storing information in those memory cells.

A host of the memory device, such as a controller or operating system, may track errors across different locations of the memory array to determine which memory cells to take off-line. However, this may be inefficient, as the host must keep track of various information/operations already performed by the memory such as the mapping between logical and physical addresses in the array. There may be a need for memory device to generate the information about which memory cells should be offlined.

### BRIEF DESCRIPTION OF THE DRAWINGS

FIG. 1 is a block diagram of a memory system according to some embodiments of the present disclosure.

FIG. 2 is a block diagram of a semiconductor device according to some embodiments of the disclosure.

FIG. 3 is a block diagram of an off-lining logging logic circuit according to some examples of the present disclosure.

FIG. 4 is a flow chart of a method of off-lining logging according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems (e.g., memory systems), apparatuses (e.g., memory devices, circuits, semiconductor devices), methods, or combinations thereof, reference is made to the accompanying drawings which form a part hereof, and which are shown by way of illustration specific embodiments in which the described systems, apparatuses, and methods may be practiced. These embodiments are described in sufficient detail to enable those skilled in the art to practice presently disclosed systems, apparatuses, and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Memory devices store information in memory arrays. The memory array includes memory cells, organized at the intersection of word lines (rows) and bit lines (columns). Each memory cell may store a bit of information. During an access operation, a row address may be used to specify a word line and a column address may be used to specify one or more bit lines. The information in the memory cells at the intersection of the specified word line and bit lines may be accessed. The memory array may have other levels of organization. For example, the array may be divided into banks, each of which includes multiple sections, with each section including several word lines. Similarly, each bank may be organized into column planes, each including several bit lines. The bank may be specified by a bank address.

Memory devices may include error correction circuits. For example, an error correction code (ECC) circuit may generate error correction bits during a write operation based on received data, and the data and associated error correction bits are written to the array. During a read operation, data and its associated error correction bits are read out to the ECC circuit, which uses to error correction bits to determine if there is an error, and if it is correctable, correct the error in the read data before it is provided off the device. As well as checking during read operations, some memories may perform error check and scrub (ECS) operations, where they go through the array on a row-by-row basis to check for and correct errors in information stored in the array. The memory may collect information about the number of errors detected, the addresses of the memory cells where the error was detected or combinations thereof.

A host device may operate the memory for example by writing data to the memory device and reading data from the memory device. By providing addresses as part of access operations, the host device may determine where information is stored on the memory device. The host device may choose to off-line some portions of the memory device, for example to avoid regions of the memory array where errors are more common. When a region is off-lined the host may avoid storing information in those regions, for example by not writing or reading information from the range of addresses associated with the off-lined region. In a conventional memory system, the host may track errors to determine which regions of the array to off-line. However, this may be inefficient as it requires the host to receive error tracking information from the memory and to know the relationship between address values and the physical arrangement of the array.

The present disclosure is drawn to apparatuses, systems, and methods for memory device error logging for off-lining. An example memory device of the present disclosure includes off-lining logging circuitry. The memory includes error correction circuits which identify errors and provide address information about the location where the data with the error was stored. The address information may include a row address, column address, bank address, or combinations thereof. The off-lining logging circuit identifies candidate portions of the array for off-lining based on the locations and number of errors detected by the error correction circuit. The off-lining logging circuit generates off-lining candidate addresses which indicate the off-lining candidate regions. A host may use the off-lining candidate addresses to determine whether or not to off-line portions of the memory array.

In an example implementation the off-lining logging circuitry includes an address masking circuit which determines a portion of the memory array which includes the address information. For example, the address masking circuit may determine a section based on the row address, determine a column plane based on the column address, or both. The off-lining circuitry includes an error tracking circuit which counts a number of errors detected in the portion. For example, the error tracking circuit may store a count value associated with the portion and update the count value responsive to the number of errors detected in the portion. If the count crosses a threshold, the memory may identify the portion as a candidate for off-lining. For example, the off-lining logging circuitry may include an address generation circuit which generates off-lining candidate address information about the address range associated with the identified portion. The off-lining candidate address information may be stored, for example in a mode register of the memory device. The host may check that information and then decide whether or not to off-line the portion that the memory identified. In this manner, the memory may handle determining portions to be off-lined.

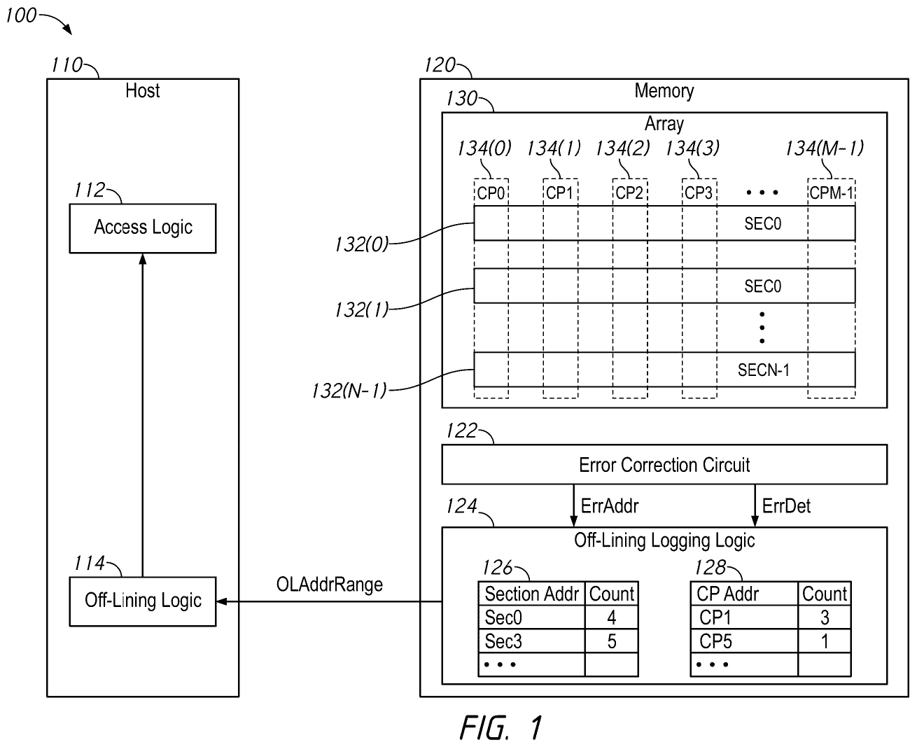

FIG. 1 is a block diagram of a memory system according to some embodiments of the present disclosure. The memory system 100 includes a host 110 and a memory device 120. The host 110 operates the memory device 120, for example by performing access operations such as write operations to store information in the memory device 120 and read operations to retrieve information stored in the memory device 120. The memory device 120 includes a memory array 130. The memory device generates off-lining candidate address information OLAddrRange which indicates one or more portions of memory array 130 which the memory device 120 has identified as being particularly error prone. The host 110 may then determine whether or not to off-line the portion(s) of the array identified by the memory device 120.

The memory device 120 includes a memory array 130, an error correction circuit 122 and an off-lining logging logic circuit 124. The array 130 is sub-divided into multiple sections 132(0) to 132(N-1) and into multiple column planes 134(0) to 134(M-1). The off-lining logging logic circuit 124 identifies one or more portions of the array 130 as off-lining candidates, for example one or more sections 132, column planes 134 or combinations thereof based on errors detected by the error correction circuit 122. The off-lining logic circuit 124 provides off-lining candidate address information OLAddrRange associated with the identified one or more candidate portions. The host 110 includes an access logic circuit 112 and an off-lining logic circuit 114. The off-lining logic circuit 114 receives the off-lining candidate address information OLAddrRange and determines whether or not to off-line the identified one or more portions. The access logic circuit 112 will stop performing access operations on the off-lined one or more portions.

The array 130 may be sub-divided into one or more levels of organization. The organization may reflect physical levels of organization, logical levels of organization, or combinations thereof. For example, word lines may be grouped together in different sections 132. Each section 132 may generally include multiple word lines. The different sections 132 are separated from each other by a strip of sense amplifiers, each coupled to a bit line extending into the two adjacent sections 132. Since the sections 132 are organized based on word lines, a row address may specify which section 132 is being accessed. For example, a first range of row address values may specify a first section 132(0), a second range of row address values may specify a second section 132(1) and so forth.

The memory array 130 may also be organized into column planes 134. Each column plane 134 may share a set of input/output lines such as local input/output (LIO) lines. During an access operation, a column select signal selects a set of bit lines within one or more of the column planes 134 to be coupled to the LIO lines and through them to circuitry outside the array 130. The column select signal may be generated based on the column address.

In some embodiments, the memory array 130 may also be organized into multiple banks. Each bank may include its own set of sections 132 and column planes 134. The bank is specified by a bank address. For the sake of brevity, FIG. 1 is generally described with respect to a single bank, however the description of FIG. 1 may generally be extended to multiple banks by taking the bank address into account.

The error correction circuit 122 detects errors in information read from the array 130 and if possible, corrects the detected error. For example, during a write operation the error correction circuit 122 receives data and generates error correction bits (e.g., parity bits) based on the data, and then writes the data and error correction bits to the array. In some example embodiments, a column plane 134 may be set aside to store the error correction bits. During a read operation, the error correction circuit 122 receives the data and its associated error correction bits and checks for errors in the data based on the error correction bits. For example, the error correction circuit 122 may implement single error correction (SEC) where up to one bit of error in the data may be located and corrected. As well as during read operations, the memory 120 may perform ECS operations, where data is read out to the error correction circuit 122, checked for errors, and then any corrections are written back to the array 130.

When the error correction circuit 122 detects an error, whether correctable or not, it provides information about where the error was detected. For example, the error correction circuit 122 may provide an error address ErrAddr which specifies a row address, column address, bank address, or combination thereof where the error was detected. The error correction circuit 122 may also provide an error detected signal ErrDet to indicate that an error was detected. In some embodiments, the error detected signal ErrDet may include additional information. For example, if the error address ErrAddr is a row address, the error detected signal ErrDet may indicate how many errors were located along the word line associated with that row address.

The off-lining logging logic circuit 124 compiles the information from the error correction circuit 122 to determine how many errors are associated with different portions of the array 130. Based on that information, the off-lining logic circuit 124 determines if one or more portions of the array 130 should be off-lined. The off-lining logic circuit 124 decodes the addresses where the errors were located to determine which portion(s) of the array 130 they are associated with, and then and counts the number of errors in those portions. If the count crosses a threshold, the portion may be identified as an off-lining candidate portion.

In an example implementation, the off-lining logging logic circuit 124 may identify portions based on the section 132, column plane 134, or combinations thereof. However, different levels of organization for identifying portions of the array 130 for off-lining may be used in other example embodiments.

In an example implementation, the off-lining logging logic circuit 124 may include one or more registers such as content addressable memory (CAM) registers. For example, FIG. 1 shows a section register 126 and a column plane register 128. However, other ways of tracking errors may be used in other example embodiments. For example, a single register may be used for both section and column plane tracking in other example embodiments.

Each of the registers 126 and 128 may be made from an array of CAM cells, organized into slots each of which stores one or more address values and an associated count. When the address ErrAddr is received, it is decoded to determine what section 132 and/or column plane 134 is associated with the error address ErrAddr. A portion address is generated which indicates the section and/or column plane associated with the error address. For example, a row address may be decoded into a section address 132 and a column address may be decoded into a column plane address. The portion address is compared to the contents of the appropriate register 126 and 128. For example, the section address is compared to the section addresses already stored in the register 126 and the column plane address is compared to the column plane addresses already stored in the register 128. If there is a match, the count value associated with that stored portion address is updated (e.g., by adding the new number of errors detected to the existing count value). If there is not a match, the address is added to the register 126/128 and the count value is set to the value of the number of errors detected. In some embodiments, if the new portion address is not already in the register and the register is full, then the slot with the lowest count value may be overwritten. If the count value crosses a threshold value, for example by being greater than or greater than or equal to the threshold value, the portion associated with the portion address may be identified as an off-lining candidate portion.

The off-lining logging logic circuit 124 may generate the off-lining candidate address information OLAddrRange based on the identified off-lining candidate portion(s). For example, the off-lining logging logic circuit 124 may generate the address information to indicate the portions whose counts have crossed the threshold. For example, the information OLAddrRange may be information which indicates the range of row addresses associated with a section 132 identified as an off-lining candidate. In some embodiments, the off-lining candidate address information OLAddrRange may be provided to the host 110. In some embodiments, the off-lining candidate address information OLAddrRange may be stored, for example in a mode register of the memory 120 or an SPD chip of a module that the memory 120 is part of.

The host 110 represents one or more devices which operates the memory. For example, the host 110 may be a memory controller, a processor, an operating system running on that processor or combinations thereof. The host 110 includes access logic 112 which directs access operations on the memory device 120. For example, the access logic 112 may determine where to store information in the array 130 by determining which addresses to use when writing and reading data. The host 110 includes an off-lining logic circuit 114 which receives the off-lining candidate address information OLAddrRange. For example, the host 110 may perform a mode register read operation to retrieve OLAddrRange. The off-lining logic 114 may off-line the portions indicated by OLAddrRange for example by directing the access logic 112 to stop storing information in the portions indicated by OLAddrRange.

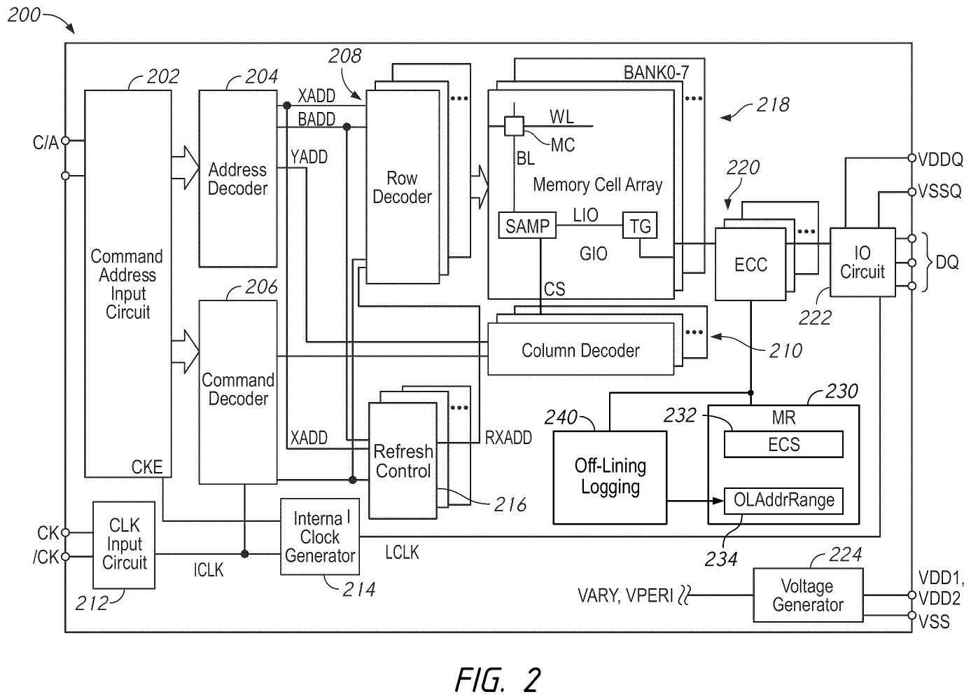

FIG. 2 is a block diagram of a semiconductor device according to some embodiments of the disclosure. The semiconductor device 200 may be a semiconductor memory device, such as a DRAM device integrated on a single semiconductor chip. For example, the device 100 may implement the memory device 120 of FIG. 1. In some embodiments, multiple memory devices, such as the device 200, may be packaged together onto a module. In some embodiments, the memory device 200 may be a stand alone memory device which is not packaged together onto a module.

The semiconductor device 200 includes a memory array 218 (e.g., 130 of FIG. 1). The memory array 218 may be organized into one or more memory banks. In the embodiment of FIG. 2, the memory array 218 is shown as including eight memory banks BANK0-BANK7. More or fewer banks may be included in the memory array 218 of other embodiments.

Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 208 based on a row address XADD and the selection of the bit lines BL is performed by a column decoder 210 based on a column address YADD. In the embodiment of FIG. 2, the row decoder 208 includes a respective row decoder for each memory bank and the column decoder 210 includes a respective column decoder for each memory bank. The address decoder 204 may use the bank address BADD to determine which column decoder 210 and row decoder 208 to use, in turn determining which bank is accessed.

The bit lines BL are coupled to a respective sense amplifier (SAMP). Read data from the bit line BL is amplified by the sense amplifier SAMP, and transferred to an ECC circuit 220 (e.g., 122 of FIG. 1) over local data lines (LIO), transfer gate (TG), and global data lines (GIO). Conversely, write data outputted from the ECC circuit 220 is transferred to the sense amplifier SAMP over the complementary main data lines GIO, the transfer gate TG, and the complementary local data lines LIO, and written in the memory cell MC coupled to the bit line BL.

The semiconductor device 200 may employ a plurality of external terminals, such as solder pads, that include command and address (C/A) terminals coupled to a command and address bus to receive commands and addresses, clock terminals to receive clocks CK and /CK, data terminals DQ coupled to a data bus to provide data, and power supply terminals to receive power supply potentials VDD, VSS, VDDQ, and VSSQ. The external terminals may couple directly to the controller (e.g., such as host 110 of FIG. 1), may couple to various buses/connectors of the module (e.g., 102 of FIG. 1), or combinations thereof.

The clock terminals are supplied with external clocks CK and /CK that are provided to an input circuit 212. The external clocks may be complementary. The input circuit 212 generates an internal clock ICLK based on the CK and /CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data. The input/output circuit 222 may include one or more interface connections, each of which may be couplable to one of the DQ pads. For example, the solder pads may act as external connections to the device 200.

The C/A terminals may be supplied with memory addresses. The memory addresses supplied to the C/A terminals are transferred, via a command/address input circuit 202, to an address decoder 204. The address decoder 204 decodes the address into a bank address, row address, and column address. The bank address BADD selects the row decoder 108 and column decoder 110 and thus selects the bank. The address decoder 204 supplies a decoded row address XADD to the row decoder 208 selected by BADD and supplies a decoded column address YADD to the column decoder 210 selected by BADD. The decoded row address XADD may be used to determine which row is opened or activated, coupling the memory cells along the activated word line to the intersecting bit lines. The column decoder 210 provides a column select signal CS based on the column address YADD. The CS signal selects which bit lines are coupled to local input/output lines, allowing those bit lines to be accessed.

The C/A terminals may be supplied with commands. Examples of commands include timing commands for controlling the timing of various operations, access commands for accessing the memory, such as read commands for performing read operations and write commands for performing write operations, refresh commands such as all-bank refresh and partial bank refresh, as well as other commands and operations. The access commands may be associated with one or more row address XADD, column address YADD, and bank address BADD to indicate the memory cell(s) to be accessed.

The commands may be provided as internal command signals to a command decoder 206 via the command/address input circuit 202. The command decoder 206 includes circuits to decode the internal command signals to generate various internal signals and commands for performing operations. For example, the command decoder 206 may provide signals such as a read signal R, write signal W, row activation signal ACT, row pre-charge signal PRE or combinations thereof. The command decoder 206 may also perform other functions, such as providing a refresh signal responsive to a refresh command.

In an example write operation, the device 200 writes data received at the DQ terminals to the memory cells specified by a received bank, row and column address. As part of the write operation, the command decoder 206 receives a write command and activation command and provides internal signals such as W and ACT/PRE. The write data is received by the IO circuit 222 and provided to the ECC circuit 220. The ECC circuit 220 generates error correction bits based on the write data. The row decoder 208 selected by BADD activates the row selected by XADD responsive to the internal activation signal ACT. The column decoder 210 selected by BADD couples the bit lines selected by YADD to the LIO and GIO lines to the RWAMP circuit 220. The sense amplifiers drive the voltages on the coupled bit lines to write the write data and the error correction bits to the memory cells at the intersection with the active word line. The row is pre-charged responsive to the pre-charge signal PRE.

In an example read operation, the device 200 reads data and its associated error correction bits from the memory cells specified by a received bank, row, and column address and provides that read data to the DQ terminals. As part of the read operation, the command decoder 206 receives a read command and an activation command and provides internal signals such as a read signal R, and ACT/PRE. The row decoder 208 selected by BADD activates the row selected by XADD responsive to the internal row activation signal ACT. The column decoder 210 selected by BADD couples the bit lines selected by YADD to the LIO and GIO lines to the ECC circuit 220. The ECC circuit 220 determines if there is an error in the read data based on the read data and the associated error correction bits. If there is an error, and it is a correctable error, the ECC circuit 220 corrects the error, for example by changing a state of the bit(s) where the error is located. The ECC circuit 220 provides the corrected read data to the IO circuit 222 and the IO circuit 222 provides the corrected read data to the DQ terminals. The row is pre-charged responsive to PRE.

The device 200 may perform ECS operations over the course of an ECS cycle. For example, the ECS cycle may last 24 hours in some embodiments. Over the course of an ECS cycle, the device 200 performs an ECS operation on each piece of information (e.g., all locations) within the array 218. As part of an ECS operation, the data and its associated error correction bits are read out to the ECC circuit 220, the ECC circuit 220 determines if there are any errors, corrects them if possible, and writes the corrected information back to the original location in the array 218. Over the course of an ECS cycle the ECC circuit 220 may generate one or more pieces of ECS information, such as the row address of the word line with the highest number of errors, the total number of errors detected, or combinations thereof. The ECS information may be stored in a mode register 230.

The device 200 includes a refresh control circuit 240. The refresh control circuit 240 provides one or more refresh addresses RXADD to the row decoder responsive to an refresh signal in order to perform a refresh operation. Responsive to the refresh address(es) RXADD, the row decoder 208 refreshes the memory cells along one or more word lines associated with RXADD as part of the refresh operation. In this manner, information may be maintained in the memory cells of the array 218.

The device 200 includes a mode register 230. The mode register includes one or more storage elements, such as latch circuits, organized in registers. The registers store information such as settings of the memory, information about the memory, or combinations thereof. A controller (e.g., 150 of FIG. 1) may perform a mode register read operation to retrieve information from a specified register or a mode register write operation to write information to a specified register. Some registers may be read only to prevent the controller from modifying them. Some registers may be updated based on conditions or operations of the memory. For example, a refresh rate multiplier register may be set based on a measured temperature of the array 218.

The device includes an off-lining logging circuit 240. The off-lining logging circuit 240 uses information from the ECC circuit 220 to determine candidate portions of the array 218 for off-lining. The off-lining logging circuit 240 may receive information such as addresses where errors were detected, a number of errors detected, or combinations thereof. In some embodiments, the off-lining logging circuit 240 may receive ECS information. The off-lining logging circuit 240 may count a number of errors in different portions of the array 218 (e.g., such as column planes, sections, or combinations thereof) to determine if one or more of those portions is a candidate for off-lining. The off-lining logging circuit provides off-lining candidate address information 234 which is stored in the mode register 230.

The power supply terminals are supplied with power supply potentials VDD and VSS. The power supply potentials VDD and VSS are supplied to an internal voltage generator circuit 224. The internal voltage generator circuit 224 generates various internal potentials VARY, and the like based on the power supply potentials VDD and VSS supplied to the power supply terminals.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

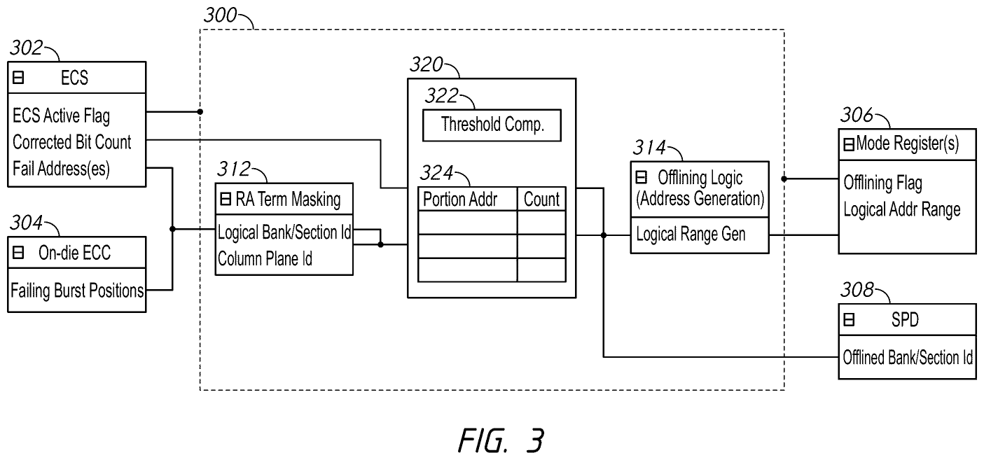

FIG. 3 is a block diagram of an off-lining logging logic circuit according to some examples of the present disclosure. The off-lining logging circuit 300 may, in some embodiments, implement the off-lining logging circuit 124 of FIG. 1, 240 of FIG. 2, or combinations thereof. The off-lining logging circuit 300 includes a masking circuit 312, an error tracking circuit 320, and an off-lining address generator circuit 314. As well as the off-lining logging logic circuit 300, FIG. 3 also shows selected other components relevant to describing the off-lining logging, such as an ECS logic circuit 302 (which may be part of the error correction circuit 122 of FIG. 1 and/or the ECC circuit 220 of FIG. 2), an error correction circuit 304 (e.g., 122 of FIG. 1 and/or 220 of FIG. 2), a mode register 306 (e.g., 230 of FIG. 2), and an SPD 308. The components 302-306 may be part of the memory device (e.g., 120 of FIG. 1 and/or 200 of FIG. 2). The SPD 308 may located on a memory module which includes several memory devices including the memory device.

The ECS logic circuit 302 generates ECS information (e.g., 232 of FIG. 2), such as an ECS Active Flag to indicate that an error was detected, a corrected bit count that records a number of bits which were corrected in memory cells specified by one or more fail addresses. The fail addresses may include one or more row addresses, column addresses, bank addresses, or combinations thereof. Similarly, the ECC circuit 304 provides address information related to detected errors. In the example of FIG. 3, the ECC circuit 304 provides a burst position of the failed bit within a set of data being read out. When the burst position is active, it may indicate both that an error was detected in the read data and where within the read data the error was detected. In some embodiments, when the ECC circuit 304 specifies a burst position, the off-lining logging logic circuit 300 may grab other address information, such as one or more of the row, column, and bank address from their respective address buses within the memory in order to determine further information about where in the memory array the failed bit was stored.

The off-lining logging logic circuit 300 includes a masking circuit 312. The masking circuit 312 receives one or more pieces of address information which specify where one or more failed bits were stored in the array. For example, the masking circuit 312 may receive one or more of a row address, column address, burst position, or bank address when an error is detected. The masking circuit 312 uses the address information to determine which portion(s) of the array the failed bit(s) were stored in and generates a portion address. For example, the masking circuit 312 may mask certain bits of one or more addresses to extract the subset of the bits of the address which are relevant to the level of organization of the array at which off-lining is being tracked. The selected subset of bits of the address forms the portion address. Which bits of which addresses are being masked may depend on the level of granularity desired for off-lining.

For example, in some embodiments, the masking circuit 312 may determine a section (e.g., 132 of FIG. 1) that included the word line where the error was stored. The row address may have one or more bits which specify a section of the array. Those one or more bits may be considered a section address. The masking circuit 312 may mask the other information in the row address and provide the section address to the error tracking circuit 320. In an analogous fashion the column address, burst position, or combinations thereof may be used to determine a column plane (e.g., 134 of FIG. 1) where the error was located in order to generate a column plane address.

The error tracking circuit 320 receives the portion address from the masking circuit 312. The error tracking circuit 320 may also receive an error count (e.g., corrected bit count from the ECS information 302) in some embodiments. The error tracking circuit 320 includes one or more registers 324 (e.g., 126/128 of FIG. 1), such as CAM registers. Each register is organized into one or more slots, each of which stores a portion address and an associated count value. In some embodiments, there may be a register 324 for each level of organization used for off-lining. For example, there may be a section register, a column plane register, or both. When a portion address is received from the masking circuit 312, it is compared to the portion addresses already stored in the register 324. If there is a match, the count value of the slot already storing the portion address is updated. In some embodiments, the count value may be incremented. In some embodiments, the count value may be changed by an amount based on the corrected bit count from the ECS information 302. In some embodiments, the count value may be incremented if the ECS active flag is inactive, and may be increased by the corrected bit count if the ECS active flag is active.

The error tracking circuit 320 compares the count values in the one or more registers 324 to one or more thresholds using a threshold comparator circuit 322. In some embodiments, the threshold comparator circuit 322 may use different thresholds for different registers 324. For example, a section threshold may be used for a section register, a column plane threshold may be used for a column plane register, and so forth. If the threshold comparator circuit 322 determines that the count value has crossed the threshold, the portion address in the associated slot may be provided as a candidate for off-lining. In some embodiments, the register 324 may have slots for each possible value of the portion address and the portion address provided by the masking circuit 312 may be used to index which count value is changed. In some embodiments, when the portion address is provided, the slot which stored the portion address may be cleared and the count value reset. In some embodiments, the register 324 may have fewer slots, and if portion address does not match one of the stored addresses, it may be added to the register 324. When an address is added, it may be added to an empty slot, or if there are no empty slots, the slot with the lowest count value may be overwritten.

The off-lining address generator circuit 314 receives the portion address from the error tracking circuit 320. The off-lining address generator circuit generates off-lining candidate address information (e.g., OLAddrRange of FIG. 1). For example, based on the identified portion, the off-lining address generator circuit 314 may generate a range of address values which specify the portion. For example, if the portion address is a section address, the off-lining address generator circuit 314 may output the range of row address values which are associated with that portion. Other ways of specifying the portion may be used in other example embodiments. For example, the off-lining candidate address information may include a first address of the portion and in some embodiments may also include information such as the number of addresses in the portion or the last address in the portion.

The off-lining candidate address information may be stored, for example in the mode register 306, the SPD 308 or combinations thereof. In some embodiments, some off-lining information may be stored in the mode register 306 while other information is stored in the SPD 308.

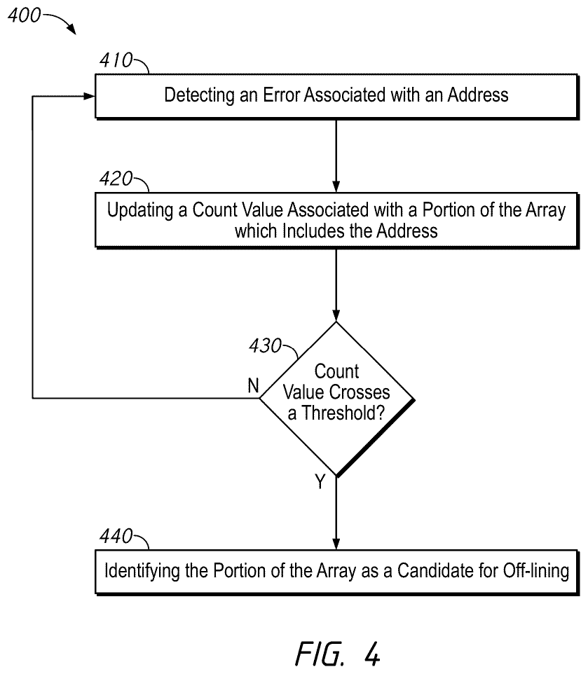

FIG. 4 is a flow chart of a method of off-lining logging according to some embodiments of the present disclosure. The method 400 may, in some embodiments, be performed by one or more of the apparatuses or systems described herein. For example, the method 400 may be implemented by an off-lining logging logic circuit such as 124 of FIG. 1, 240 of FIG. 2, 300 of FIG. 3, or combinations thereof.

The method 400 begins with box 410, which describes detecting an error associated with an address. The method 400 may include detecting the error with an error correction circuit (e.g., 122 of FIG. 1, 220 of FIG. 2, 304 of FIG. 3, or combinations thereof). The method 400 may include detecting the error during a read operation or during an ECS operation. In some embodiments, the method 400 may include performing ECS operations and then updating ECS information based on the detected errors and addresses.

Box 410 is followed by box 420, which describes updating a count value associated with a portion of the array which includes the address. The method 400 may include updating the count value in a register (e.g., 126/128 of FIG. 1, 324 of FIG. 3, or combinations thereof) of the off-lining logic circuit. The method 400 may include masking the address to determine a portion address associated with the portion. The portion may be a section or a column plane in some embodiments. The method 400 may include comparing the portion address to stored portion addresses in the register. If there is a match, the method 400 may include updating the count value associated with the matching stored portion. If there is not a match, the method 400 may include storing the portion address. In some embodiments, the method 400 may include updating the count value by incrementing the count value. In some embodiments, the method 400 may include changing the count value by an amount of errors detected in the memory cells associated with the address.

Box 420 is followed by box 430, which describes determining if the count value crosses a threshold. For example, box 430 may include determining if the count value is greater than, or greater than or equal to, a threshold value. If the count value has not crossed the threshold, the method 400 may return to box 410. If the count value has crossed the threshold, the method 400 may proceed to box 440. Box 440 describes identifying the portion of the array as a candidate for off-lining. In some embodiments, the method 400 may include generating off-lining candidate address information, for example with an off-lining address generator circuit such as 314 of FIG. 3.

In some embodiments, the method 400 may include storing the off-lining candidate address information, for example in a mode register of the memory, an SPD of a module which includes the memory, or combinations thereof. In some embodiments, the method 400 may include reading the off-lining candidate address information with a controller and off-lining the portion of the array associated with the off-lining candidate address information.

In an example implementation, the method 400 may include detecting an error along memory cells of a word line associated with a row address. The method 400 may include masking the row address to determine a section of the memory array which includes the word line, and updating a count value associated with the section. Instead, or in addition, the method 400 may include detecting an error along memory cells in a column plane, masking a column address to determine the column plane, and updating a count value associated with the column plane.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a memory array;
an error correction circuit configured to detect if there is an error in information stored in the memory array, wherein a location of the information within the memory array is specified by one or more addresses;
an off-lining logic circuit configured to determine a portion of the array based on the one or more addresses, determine if the portion is an off-lining candidate based, in part on a number of errors detected in the portion, and provide off-lining candidate address information associated with the portion if the portion is an off-lining candidate.

2. The apparatus of claim 1, wherein the off-lining logic circuit is further configured to update a count value associated with the portion and determine that the portion is an off-lining candidate if the count value crosses a threshold.

3. The apparatus of claim 2, wherein the error correction circuit is configured to provide error correct and scrub (ECS) information which includes a quantity of errors detected in the location within the memory array, and wherein the off-lining logic circuit is configured to update the count value by an amount based on the quantity of errors.

4. The apparatus of claim 1, wherein the one or more addresses includes a row address, column address, bank address, or combinations thereof; and
wherein the portion is a section of the memory array, a column plane of the memory array or a combination thereof.

5. The apparatus of claim 1, wherein the off-lining logic circuit is further configured to write off-lining candidate address information to a mode register, a serial presence detect (SPD) chip, or both.

6. The apparatus of claim 1, wherein the off-lining logic circuit comprises:
a masking circuit configured to mask the one or more addresses to determine a portion address;
an error tracking circuit configured to update a count value associated with the portion address and determine if the count value crosses a threshold; and
an address generator circuit configured to generate the off-lining candidate address information based on the portion address if the count value crosses the threshold.

7. The apparatus of claim 6, wherein the error tracking circuit includes a content addressable memory (CAM) register configured to store a plurality of portion addresses and a plurality of count values each associated with a respective one of the plurality of portion addresses.

8. The apparatus of claim 7, wherein the error tracking circuit is configured to compare the portion address from the masking circuit to the stored plurality of portion addresses and if there is a match update the associated one of the plurality of count values and if there is not a match store the portion address.

9. A method comprising:
detecting an error associated with an address;
updating a count value with an off-lining logging circuit of a memory device, wherein the count value is associated with a portion of the array which includes the address;
determining if the count value has crossed a threshold; and
identifying the portion of the array as a candidate for off-lining.

10. The method of claim 9, further comprising:
detecting a quantity of errors associated with the address as part of error correct and scrub (ECS) information; and
updating the count value by an amount based on the quantity of errors.

11. The method of claim 9, further comprising masking the address to determine the portion.

12. The method of claim 11, further comprising masking a row address to determine a section as the portion, masking a column address to determine a column plane as the portion, or combinations thereof.

13. The method of claim 9, further comprising:
comparing a portion address associated with the portion to a plurality of stored portion addresses in a content addressable memory (CAM) register;
determining if the portion address matches one of the plurality of stored portion addresses;
updating a stored count value associated with a matching one of the plurality of stored portion addresses; and
storing the portion address in the CAM register if there is not a matching one of the plurality of stored portion addresses.

14. The method of claim 9, further comprising generating off-lining candidate address information based on the identified portion.

15. The method of claim 9, further comprising storing the off-lining candidate address information.

16. The method of claim 9, further comprising off-lining the identified portion with a host of the memory device.

17. A system comprising:
a memory device comprising:
a memory array;
an error correction circuit configured to detect if there is an error in information stored in the memory array, wherein a location of the information within the memory array is specified by one or more addresses; and
an off-lining logic circuit configured to determine a portion of the array based on the one or more addresses, determine if the portion is an off-lining candidate based, in part on a number of errors detected in the portion, and provide off-lining candidate address information associated with the portion if the portion is an off-lining candidate; and
a host device configured to off-line the portion based on the off-lining candidate address information.

18. The system of claim 17, wherein the memory device further comprises a mode register configured to store the off-lining candidate address information, and
wherein the host device is configured to read the off-lining candidate address information from the mode register.

19. The system of claim 17, wherein the host device comprises an access logic circuit configured to not read from or write to the off-lined portion of the memory array.

20. The system of claim 17, wherein the off-lining logic circuit is further configured to update a count value associated with the portion and determine that the portion is an off-lining candidate if the count value crosses a threshold.
